(19) United States
(12) Patent Application Publication
(10) Pub. No.: US 2006/0039271 A1
(43) Pub. Date: Feb. 23, 2006

(54) Power Controlled Interleave-division Multiple-access Wireless Communication Systems

(76) Inventors: Ping Li, Hong Kong (CN); Sammy Chan, Hong Kong (CN)

Correspondence Address: SAMMY CHAN;DEPARTMENT OF ELECTRONIC ENGINEERING, CITY UNIVERSITY OF HONG KONG, TAT CHEE AVENUE, KOWLOON, HK

(21) Appl. No.: 10/711,034

(22) Filed: Aug. 18, 2004

(51) Int. Cl. H04J 11/00

(52) U.S. Cl. 370/208

(57) ABSTRACT

Transmission methods of interleave-division multiple-access (IDMA) system are disclosed. An objective of the present invention is to provide a signal structure that can substantially increase the overall transmission rate and meet the requirements of different transmission rates in wireless telecommunication systems. Such requirements arise in applications such as mixed speech and data services where different services may employ different rates for transmission. Such applications are often referred as multimedia applications. The disclosed transmission method includes an extra power control operation applied to output of an IDMA transmitter.

### FIELD OF THE INVENTION

This invention relates to methods of signal transmission in multiple-access wireless telecommunication systems based on the interleave-division multiple-access (IDMA) principle using unequal power control. Its applications include, but not limited to, mobile cellular communication systems, wireless local area network systems and other types of mobile radio systems involving a plurality of users who are transmitting signals simultaneously.

### BACKGROUND OF THE INVENTION

A basic problem in communication is how signals from a plurality of users may share a common transmission channel. This is commonly referred to as the multiple-access problem. More specifically, multiple-access refers to a situation where a plurality of users are transmitting signals simultaneously and they wish to share a common transmission media such as the free space or a fixed line. Some conventional methods to achieve multiple-access are listed as follows.
Frequency division multiple-access (FDMA). With FDMA, each user transmits signal using a unique carrier frequency.
Time division multiple-access (TDMA). With TDMA, each user transmits signal in a unique time interval.
Direct Sequence—Code division multiple-access (DS-CDMA). With DS-CDMA, each user transmits signal using a unique code sequence. This code sequence is usually referred to as a signature sequence. For example, let this signature sequence for a user be s. Then this user can transmit s and −s to represent two different information messages. This operation is usually referred to as spreading.

A detailed discussion on FDMA, TDMA, and CDMA principles can be found in John G. Proakis, Digital Communications, McGraw-Hill International Editions 1995.

A forward error control (FEC) encoder is a device that transforms a data sequence into another sequence that is referred as a ‘coded sequence’. Traditionally, FEC codes are used in communication systems to prevent error. Such FEC codes are referred as narrow sense codes below.

Codes in this document refer to any form of sequence transformation including narrow sense codes. A special case of codes is the trivial repetition code that simply repeats each symbol for several times. Another special case is the spreading operation. In conventional CDMA systems, spreading is commonly used for bandwidth expansion and is not regarded as coding. However, in this document, spreading is regarded as a special case of coding since it involves sequence transformation.

In a more general sense, any combination of narrow sense coding, repeat coding and spreading is also regarded as a coding operation or simply a ‘code’.

An interleaver is a device that performs interleaving. Here ‘interleaving’ has the same meaning as permutation, which permutes (or change the order of) the elements in a sequence.

Equal power control has been used in CDMA systems to ensure that the signals from different users have equal power when they arrive at the receiver. This is the technique used in current mobile cellular systems, such as in the up-link of the North American IS-95 CDMA standard. Although there have been an vast amount of discussion on equal power control for CDMA systems, only few experts in the art have realized the importance of unequal power control for CDMA systems. An original discussion on this topic can be found in the following paper.

A. J. Viterbi, ‘Very low rate convolution codes for maximum theoretical performance of spread-spectrum multiple-access channels,’ IEEE J. Select. Areas Commun., vol. 8, pp. 641-649, May 1990.

The above paper states that, at least theoretically, unequal power allocation could be effective for CDMA systems if multi-user detection is used. However, multi-user detection has been generally regarded as too complicated to be used in practice.

Interleave-division multiple-access (IDMA) is itself a completely new concept and therefore there has been no discussion on the power allocation issues for IDMA, except in Li Ping, Lihai Liu, Keying Wu and W. K. Leung, ‘Interleave division multiple access (IDMA) communication systems,’ Proceedings of IEEE International Conference on Communications, pp. 2864-2868, Paris, France, June 2004.

### PRIOR ART

IDMA is discussed in the following papers as an alternative to achieve multiple-access.

Li Ping, Lihai Liu and W. K. Leung, ‘A simple approach to near-optimal multi-user detection: interleave-division multiple-access,’ IEEE Wireless Communications and Networking Conference, WCNC'03, pp. 391-396.

Li Ping, Lihai Liu, Keying Wu and W. K. Leung, ‘Approach the capacity of multiple access channels using interleaved low-rate codes,’ IEEE Commun. Lett., vol. 8, pp. 4-6, January 2004.

The IDMA transmission comprises of the following steps:
(a) encoding a source data sequence using a code to produce a coded sequence, and
(b) interleaving the said coded sequence so as to modify the order of its elements to produce the interleaved sequence that is used to generate a continuous waveform to be transmitted into free-space, and
wherein interleaved sequences from different users are distinguished by using different interleaving schemes.

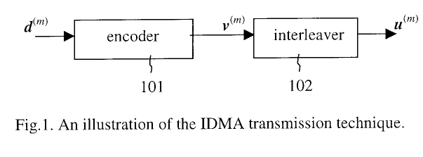

The following is a more detailed description of the IDMA transmission principle. Refer to FIG. 1 for the notations involved.

The source data sequence
d^{(m)}={d₁^{(m)}, d₂^{(m)}, . . . dₖ^{(m)}, . . . , d_{K}^{(m)}}
for user-m is used to produce a coded sequence
v^{(m)}={v₁^{(m)}, v₂^{(m)}, . . . , vₙ^{(m)}, . . . v_{N}^{(m)}}
using an encoder 101 in FIG. 1. The block labeled by interleaver 102 in FIG. 1 is a device that permutes the order of the input sequence to produce an interleaved sequence. This block is defined by a length-N sequence
b^{(m)}={b₁^{(m)}, b₂^{(m)}, . . . , bₙ^{(m)}, . . . b_{N}^{(m)}},
where each
bₙ^{(m)}
is an integer value between 1 and N and
bₙ^{(m)}≠b_{n′}^{(m)}
for any
n≠n′
. The nth element in the input sequence is permuted to the bₙ^{(m)}
-th position in the output sequence. More specifically, the input and output relationship for the block 102 is defined by

$${u}_{{b}_{n}^{( m )}}^{( m )} = {v}_{n}^{( m )}$$

. Here v^{(m)} and u^{(m)} are the coded and interleaved sequences, respectively. The interleaved sequence is used to generate a continuous waveform to be transmitted into the transmission media, which follows the standard modulation procedure in existing communication systems. The detailed discussion on modulation techniques can be found in John G. Proakis, Digital Communications, McGraw-Hill International Editions 1995.

It is interleaving that enables a receiver to detect a wanted signal in an IDMA system. Different user signals are distinguished by different interleaving methods. This means that the interleaving schemes should be significantly different from each other. The required interleaver can be implemented by a so-called ‘random interleaver’, which is defined in such a way that its elements are selected in a random manner. This does not preclude interleavers designed in other ways.

The transmission technique of the embodiment of FIG. 1 may be summarized as follows:

The IDMA Transmission Principles

The data sequenced^{(m)} of a user-m is first encoded by an encoder. This encoder can be the same or different for different users. This produces a sequence v^{(m)}.
Sequence v^{(m)} is interleaved to produce the interleaved sequence u^{(m)}.
The interleaved sequence is used to generate a continuous waveform to be transmitted into the transmission media.
Different user signals are distinguished by different interleaving methods.

### SUMMARY OF THE INVENTION

The present invention is directed to methods for signal transmission and detection in IDMA systems. An objective of the present invention is to provide a signal structure that can substantially increase the overall transmission rate and meet the requirements of different transmission rates in wireless telecommunication systems. Such requirements arise in applications such as mixed speech and data services where different services may employ different rates for transmission. Such applications are often referred as multimedia applications.

The underlying IDMA scheme in this invention does not preclude the situation that part of the user signals are distinguished by methods according to other background arts, such as by FDMA, TDMA, or CDMA or their hybrid forms.

To achieve the desired advantages and in accordance with the purpose of the present invention, as embodied and broadly described, a method of signal transmission in the present invention includes employing codes with different rates for different users in an IDMA system and employing an extra power control mechanism applied to the IDMA transmission units. According to the present invention, the IDMA signal transmission consists of the steps of:
(a) assigning a code to each user, where the said codes can be the same or different for different users and their rates can be the same or different for different users, and
(b) encoding the source data sequence for each user using the encoder assigned to this user, and
(c) interleaving the said coded sequence so as to modify the order of the said coded sequence to produce the interleaved sequence, wherein interleaved data sequences from different users are distinguished by using different interleaving schemes, and
(d) assigning a pre-calculated power level to each user, where the said power level can be the same or different for different users, but these levels are different at least for some users, and
(e) transmitting the interleaved sequence for each user using the assigned power level for this user and the signals from different users may have different power levels when they arrive at a common receiver.

### BRIEF DESCRIPTION OF THE DRAWINGS

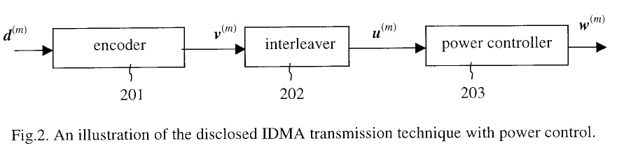

Some embodiments of the invention will now be described with reference to the accompanying drawings in FIG. 2 that is a block diagram of the transmitting unit in an IDMA system according to an embodiment of the present invention. In FIG. 2, it is possible to use different encoders with different rates for different users. The key difference between the drawings in FIG. 1 and FIG. 2 is the use of a power controller in FIG. 2.

### DETAILED DESCRIPTION OF PREFERRED EMBODIMENT

In the following description, for purpose of explanation only and without intending any limitation, specific details of exemplary embodiments are set forth, such as particular system components, techniques, etc, to provide an understanding of the invention. However, it will be apparent to the one skilled in the art that the present invention may be practiced in other embodiments that depart from these specific details. In other instances, detailed description of well-known methods, devices, and circuits are omitted so as not to obscure the description of the present invention with unnecessary details.

In the IDMA system according to an embodiment of the present invention, assume that there are M users transmitting signals simultaneously and that they share a common transmission media such as the free space or a fixed line. The M transmitters do not need to be synchronized. For simplicity, only the transmitter for one user will be discussed in detail and this user is labeled as user-m.

The source data sequence
d^{(m)}={d₁^{(m)}, d₂^{(m)}, . . . , dₖ^{(m)}, . . . d_{K}^{(m)}}
for user-m is used to produce a coded sequence
v^{(m)}={v₁^{(m)}, v₂^{(m)}, . . . , vₙ^{(m)}, . . . v_{N}^{(m)}}
using an encoder 201 in FIG. 2. The rate, denoted by R, of this encoder is R=B/N, where B is the quantity of information carried by d^{(m)} conventional measured by ‘number of bits’. See John G. Proakis, Digital Communications McGrawHill International Editions 1995. In the embodiment of FIG. 2, it is possible to use a plurality of different encoders with different rates for different users.

The block labeled by interleaver 202 in FIG. 2 is a device that permutes the order of the input sequence to produce an output sequence. It is the same device as that in FIG. 1 bearing the same name.

The block labeled by power controller 203 in FIG. 2 is a device that adjusts the power level of the transmitted signal for user-m.

In the disclosed invention, the exact transmission power levels for all users have to be carefully computed. A detailed discussion on the technical justification of the use of the power controller and the method to compute the transmission power levels is provided in the following document.

Li Ping, Lihai Liu, Keying Wu and W. K. Leung, ‘Interleave division multiple access (IDMA) communication systems,’ Proceedings of IEEE International Conference on Communications, Paris France, June 2004.

### AN EXAMPLE

Some embodiments of the invention will now be described by way of an example. Suppose that there are altogether eleven (i.e., M=11) active users in the exemplary IDMA system. The transmitter for each user includes a rate-½ convolutional code cascade with a repetition code. The encoding process is as follows. The information sequence is first encoded by the rate-½ convolutional code. Each coded bit of the rate-½ convolutional code is then repeated by N times. The values for N used in the example are 1, 2 and 4. Thus overall rates for these eleven users are ½, ¼ and ⅛. There are one user transmitting at rate ½, two users at rate ¼ and eight users at rate ⅛. The overall rate is the sum of these eleven users, i.e. the total rate is 1×½+2×¼+8×⅛=2. The signal from each user is individually and independently interleaved before transmission. The power levels for these eleven users are listed as follows.
For the eight users with rate-⅛, the transmission power level is P.
For the two users with rate-¼, the transmission power level is 2.3P.
For the user with rate-½, the transmission power level is 4P.

The above system is assessed using simulation. It has been found that the bit error rate for every user can be kept below 10⁻⁴ in an additive white Gaussian noise channel if the energy-per-information-bit-over-noise-density-ratio exceeds 4.3 dB.

1. A method for IDMA signal transmission, comprising the steps of:
(a) assigning a code to each user, where the said code can be the same or different for different users and of the same or different rates for different users, and
(b) encoding the source data sequence for each user using the encoder assigned to this user, and
(c) interleaving the said coded sequence so as to modify the order of said coded sequence to produce the interleaved sequence, wherein interleaved data sequences from different users are distinguished by using different interleaving schemes, and
(d) assigning a pre-calculated power level to each user, where the said power level can be the same or different for different users, but these levels are different at least for some users, and
(e) transmitting the interleaved sequence for each user using the assigned power level for this user

2. A method as claimed in claim 1 wherein the codes may contain a hybrid form of narrow sense codes and repeat codes and spreading operations.
